(19) United States
(12) Patent Application Publication
(10) Pub. No.: US 2005/0037182 A1
(43) Pub. Date: Feb. 17, 2005

(54) Separating plate-composite component for producing printed circuit board components and method for producing a composite component of this type

(76) Inventors: Klaus Tomaschitz, Leoben (AU); Ernst-Dieter Backhaus, Sexau (DE)

Correspondence Address: LADAS & PARRY, 26 WEST 61ST STREET, NEW YORK, NY, 10023, US

(21) Appl. No.: 10/494,884

(22) PCT Filed: Oct. 10, 2002
(86) PCT No.: PCT/AT02/00292

(51) Int. Cl. B32B 3/00

(52) U.S. Cl. 428/209; 428/901; 428/344

(57) ABSTRACT

A separating plate compound component (1) for producing printed circuit boards by compressing multilayers (2) stacked with at least one such compound component (1), which compound component (1) includes a separating plate (3) between copper foils (5), anti-adhesive layers (6) being arranged on the separating plate (3) between the latter and the copper foils (5).

The invention relates to a compound component comprising a separating plate for producing printed circuit board components by compressing stacked individual layers comprising at least one such compound component, which compound component includes a separating plate between copper foils.

The invention also relates to a method of producing such a compound component.

For producing printed circuit board components formed of several layers, in particular so-called multilayer circuit boards, or multilayers in short, it has been known to interconnect individual-layer press piles in appropriate multiplaten or vacuum presses at a temperature of, e.g., approximately 180° C. The individual arrangements are comprised of copper foils which are required for producing the conductor tracks, as well as of synthetic resin layers (prepreg layers, commonly epoxy resin layers), or laminate layers, respectively. As a rule, several such press piles are arranged in a press one above the other, and these piles are separated from each other by separating or press plates. These separating plates mainly serve the purpose of effecting a uniform pressure and temperature distribution during pressing of the multilayer, so as to obtain high-quality printed circuit board products. In most instances, the separating plates consist of steel sheet or of aluminium sheet and therefore often are also called separating sheets. Due to the function described they are to be harder than the copper foils. A production comparable to the multilayer circuit boards is conceivable in the so-called base materials for printed circuit boards which commonly are a synthetic resin layer (prepreg layer) covered on one or both sides thereof by a conductive layer (in particular a copper foil). These base materials are also used in the production of multilayer circuit boards as so-called “inner layers” and by themselves also form printed circuit board components.

The separating plates or separating sheets are components the production of which is relatively complex and expensive in the course of the printed circuit board production described, so that a repeated use thereof is desired. This, however, often is not possible due to the fact that when compressing the individual layers, during heating of the synthetic resin material in the prepreg layers, the synthetic resin material flows out over the rims of the separating plates, partially also over larger areas of the separating plates, this synthetic resin material after having cooled and solidified hardly being removable from the separating plates. This applies e.g. to the compound components according to U.S. Pat. No. 5,153,050 A, where an aluminium plate is used as separating plate, wherein copper foils are directly glued to this aluminium plate via a rim-side adhesive strip. Although this adhesive strip does keep dust particles of the synthetic resin from intruding, a contamination of the separating plate at the edges by the liquid synthetic resin cannot be avoided. Here, a further problem is also the different thermal expansion coefficient of aluminium and copper, resulting in thermal stresses in the Cu—Al—Cu laminate during the pressing process.

In DE 198 31 461 C, a compound component is suggested in which an aluminium separating sheet is enclosed between two comparatively larger copper foils, the copper foils being bag-like interconnected externally of the aluminium separating plate by gluing. In this manner, the liquid synthetic resin can be kept away from the aluminium separating sheet, and moreover, also the copper foils and the aluminium separating plate can expand differently in accordance with their different thermal expansion coefficients if the temperature is raised, e.g. to approximately 180° C., during the pressing procedure. However, the copper foils of the copper foil bag cannot be resin-coated since the resin would become liquid during the pressing procedure and would flow out beyond the rim, thereby possibly causing undesired adhesions within the press. Moreover, the projecting rim regions of the copper foils must be cut off and removed after the pressing process, recycling of these copper foils being a problem due to the synthetic resin material getting thereon during the pressing process.

It is now an object of the invention to provide a separating plate compound component, as well as an advantageous method of producing such a compound component, wherein undesired adhesions caused by liquid resin during compression of the individual layers are avoided in a simple manner, and wherein also the use of resin-coated copper foils for the compound component—for a connection with the adjacent individual layers—is enabled. These compound components nevertheless shall be simple and inexpensive to produce.

To achieve this object, the invention provides a separating plate compound component as defined in claim 1.

Advantageous embodiments and further developments of this compound component are defined in the claims which are dependent on claim 1.

Moreover, the invention advantageously provides a method as defined in the independent method claim.

In the technique according to the invention, the resin flowing out of the pile formed by the individual layers is caught by anti-adhesive layers on the separating plate, and adhesion or contamination of the separating plate itself is reliably avoided. This is so even if the copper foils, as is preferred, are resin-coated on their sides remote from the anti-adhesive layers. The copper foils then may simply be glued to the anti-adhesive layers, e.g. by means of a pressure-sensitive adhesive or a thermoplastic adhesive, in particular a hot-melt type adhesive, which ensures a sufficient adhesion on the anti-adhesive layers for the pressing procedure, yet allows for a detachment of the copper foils thereafter. Here, an advantageous variant is provided by a commercially available acrylate adhesive which decomposes during pressing at the temperatures employed. The anti-adhesive layers are also called separator layers or separator plies, and they serve to take up the liquid resin and to thereby prevent an adhesion of this liquid resin on the separating plate. Insofar also the described adhesion of the copper foils on these anti-adhesion layers is very well possible, suitable adhesives being sufficiently well known in the prior art. Substantially most of the known pressure-sensitive adhesives, or thermoplastic adhesives, respectively, can be used here.

Another connection possibility consists in that the copper foils are connected with the metal separating plate with the anti-adhesive layers being passed in the manner of spot welding, e.g. by laser beams.

The separating plate may consist of a steel sheet or of an aluminium sheet in a manner known per se, a steel sheet or high-grade steel sheet, in particular having a strength of at least 400 MPa, being preferred. It may, however, also be made of other suitable hard materials (other than metal), it merely being important that it is harder than the copper foil to be laminated thereon so as to avoid the so-called image transfer during the pressing procedure, i.e. pressing the conductor tracks of the inner layers through the outer copper foils.

An advantageous embodiment of the compound component according to the invention is characterised in that the anti-adhesive layers are formed by separate separator foils which project beyond the separating plates by a rim region and are interconnected in these projecting rim regions, the separating plate thereby being enclosed in a separator foil bag. In this instance, the separating plate may freely be movable within this separator foil bag. In this instance, the separator foils may consist of a synthetic material, such as, e.g., PET or fluoropolymers. Depending on the material of the two separator foils, the latter may be interconnected by means of a suitable adhesive or by an adhesive seam. The adhesive seam of the separator foil bag preferably can be made by means of a commercially available acrylate adhesive, pressure sensitive adhesive, or a thermoplastic adhesive, applied in the rim region of the separator foils in the form of a continuous strip.

On the other hand, a compound component particularly suitable as regards its construction and its low costs is enabled if the anti-adhesive layers are formed by anti-adhesive coatings applied to both sides of the separating plate, and if the separating plate including its anti-adhesive coatings projects beyond the copper foil on all sides thereof. In this embodiment, the separating plate with the anti-adhesive coating applied thereon thus is larger than the copper foils so that outflowing synthetic resin can be caught thereon or, rather, on the anti-adhesive coatings provided thereon. On the other hand, in the aforementioned embodiment with the separating plate provided within a separator foil bag, the separating plate and the copper foils may be of equal size since in that instance the separator foils will project beyond the rims of the separating plate and the copper foils and thus may serve to catch the outflowing synthetic resin.

The anti-adhesive coatings may also be formed of the most differing materials, such as teflon or a polyolefin, or also of a varnish.

The invention will be explained in more detail hereinafter, by way of a particularly advantageous exemplary embodiment illustrated in the drawings to which, however, it shall not be restricted. In detail,

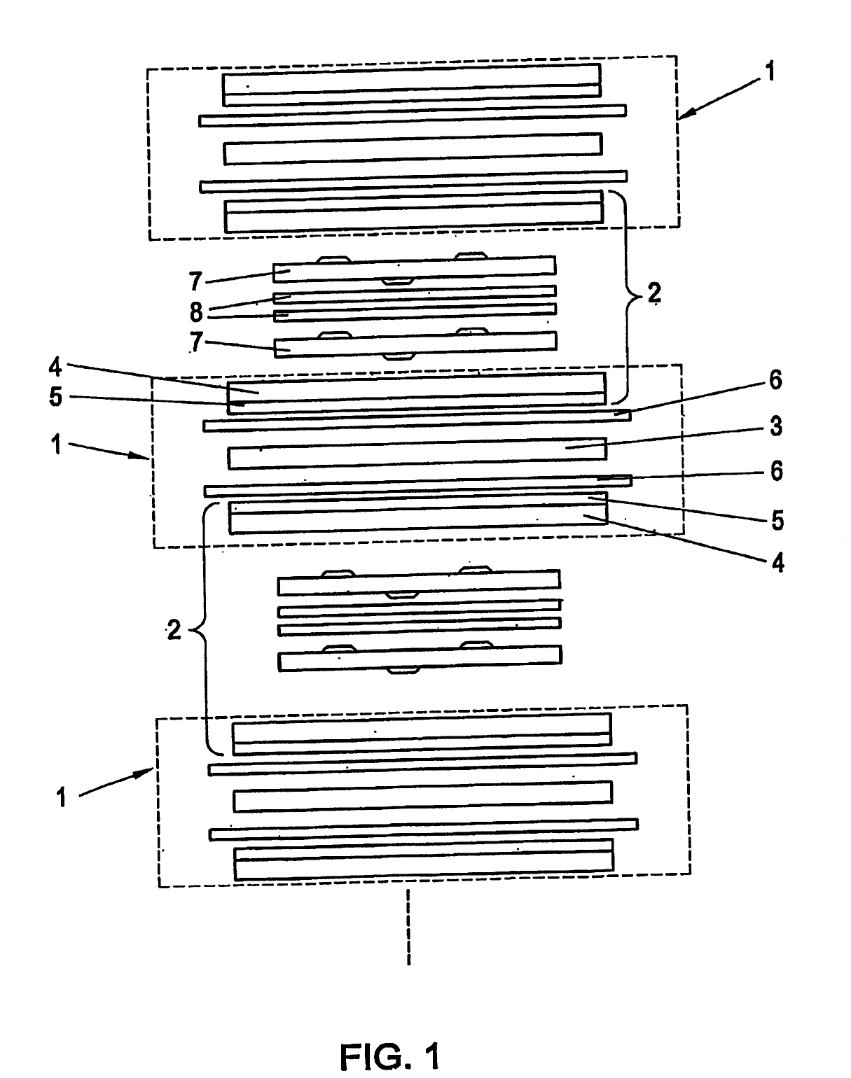

FIG. 1 shows a schematic view of an assembly of a multilayer press pile comprising several individual layers and separating plate compound components;

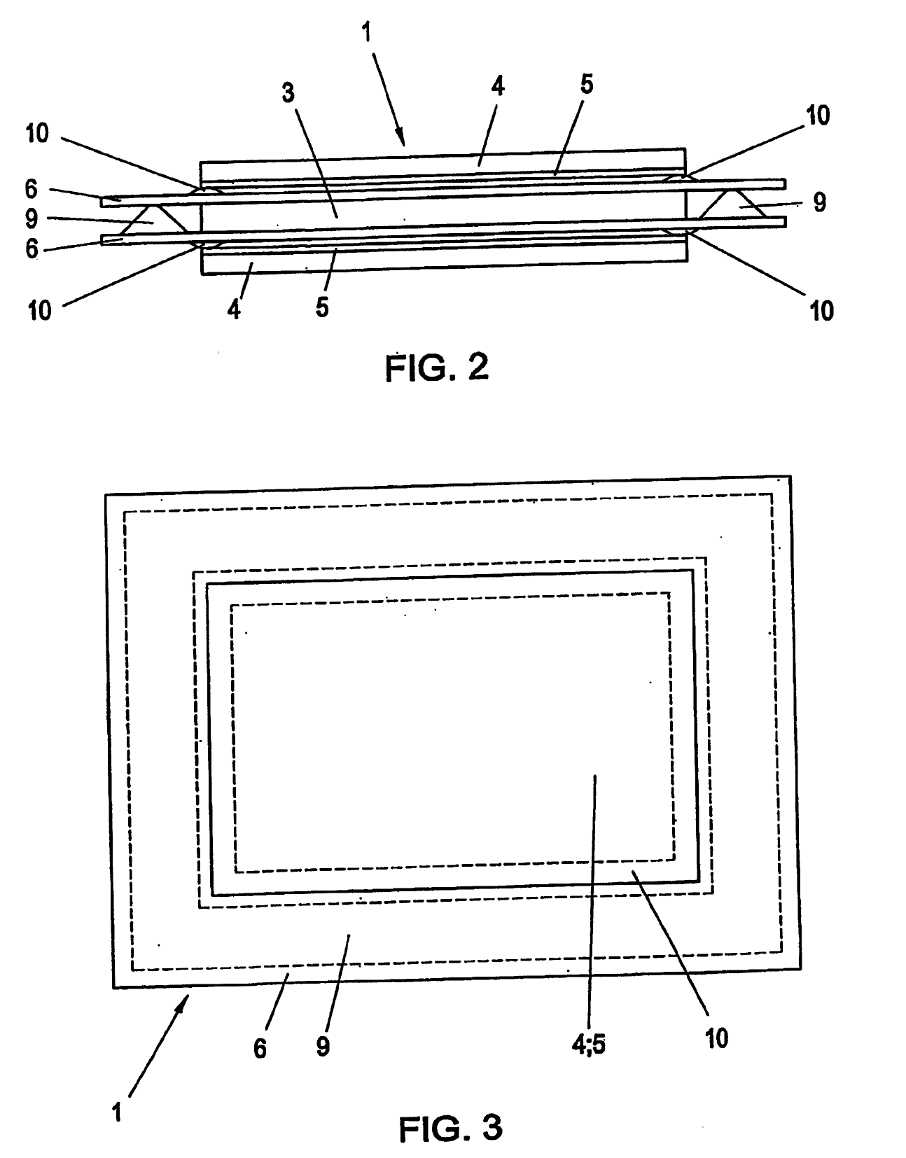

FIG. 2 schematically shows a view of a separating plate compound component comprising a separator foil bag;

FIG. 3 shows a schematic top view on such a compound component according to FIG. 2;

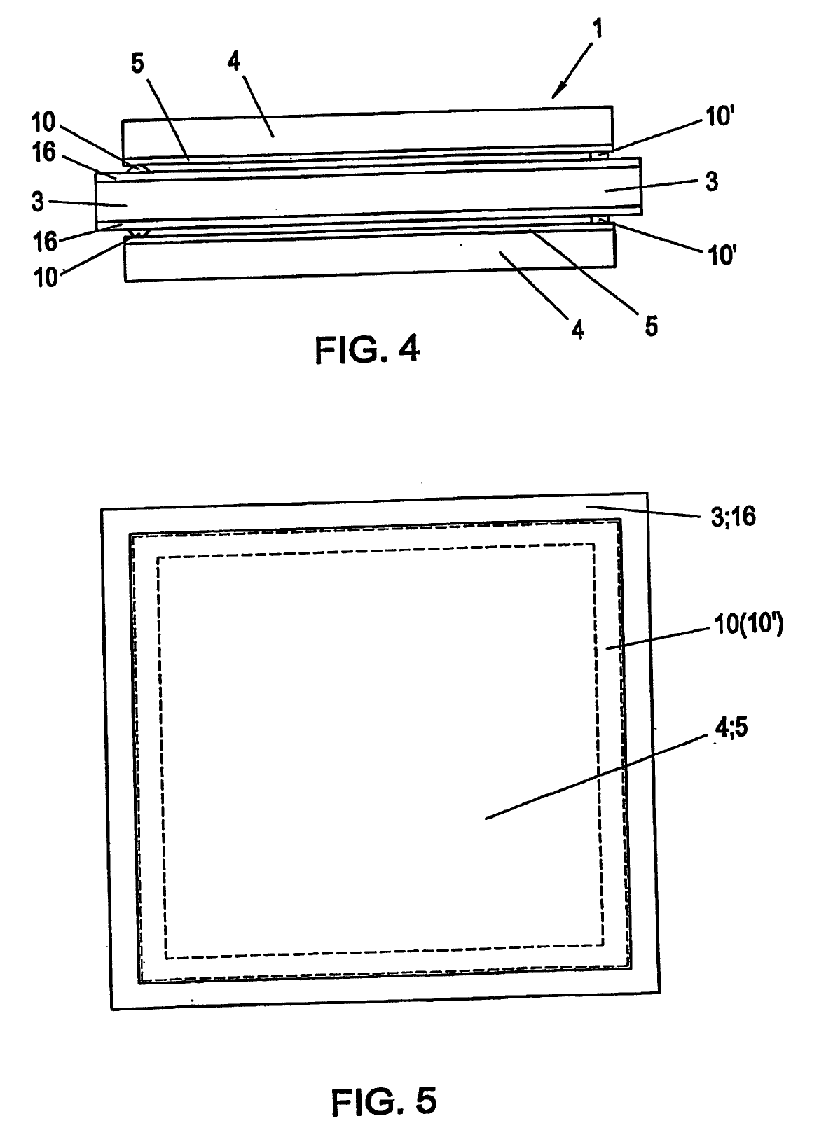

FIG. 4 shows a schematic view of another embodiment of a separating plate compound component, comprising a separating plate directly provided with anti-adhesive layers; and

FIG. 5 shows a top view on such a compound component according to FIG. 4.

In FIG. 1, a multilayer stack to be pressed is schematically and partially shown, it being visible that separating plate compound components 1 alternate with individual layer arrangements 2 for multilayer circuit boards, termed arrangements 2 in short hereinafter. Each one of the separating plate compound components 1 illustrated by broken-line rectangles comprises a separating plate 3, also termed pressing plate, separating sheet or pressing sheet, on which copper foils 5 provided with a resin coating 4 are applied via anti-adhesive layers 6, here in the form of separator foils. The entire unit with resin-coated copper foil 5, 4, separator foil 6, separating sheet 3, separator foil 6 again and synthetic resin-4-coated copper foil 5 is pre-assembled to provide compound component 1, as explained in more detail hereinafter in two exemplary embodiments, by way of FIGS. 2 and 3, on the one hand, and FIGS. 4 and 5, on the other hand.

The copper foils 4 of the compound components 1 coated with resin 5 will become part of the multilayer circuit boards, to which also etched inner layers 7 (base materials) and synthetic resin layers (prepreg layers) 8 of the arrangements 2 belong.

By the fact that such separating plate compound components 1 are provided as units and can be stacked alternately with the multilayer-individual layers in superposed relationship when producing the printed circuit board (components), stacking in the press is substantially simplified, since five components—4/5;6;3;6,5/4—can be laid at once in one single procedure. This substantially reduces the time of handling. The etched inner layers 7 realise the desired circuit or the circuit structure, respectively, and they are adhered to each other by aid of the prepreg layers 8. This connection is realised in a press at elevated temperature as well as under pressure, or in a vacuum. In such a press package, as schematically illustrated partly in FIG. 1, 20 arrangements 2 may very well be stacked one on top of the other. Between the individual arrangements 2, the separating sheet compound components 1 are laid, the separating sheets 3 providing for a smooth, clean surface of the multilayer circuit boards produced.

During the defined pressing cycle, the synthetic resin of the prepreg layers 8 begins to flow. However, by the fact that the anti-adhesive layers or separator layers 6 are provided, the resin of layers 8 is prevented from getting onto the separating sheets or, generally, on the separating plates 3. In this connection the resin must also be prevented from flowing to the edges of the separating plates 3.

In the embodiment according to FIGS. 2 and 3, separate separator foils are provided as anti-adhesive layers 6, and these separator foils 6 are larger than the separating plate 3 and also larger than the copper foils 5 with their resin layers 4. As is visible in FIG. 2, in this instance the copper foils 5 and the separating plate 3 preferably are of the same size, even though the copper foils 5 may be a little smaller than the separating plate 3. What is important, however, is that the separator foils 6 project on all sides beyond the separating plate 3 so as to catch the liquid resin. To keep the resin also from getting between the separator foils 6 to the separating plate 3, the separator foils are interconnected along an adhesive seam 9 by means of a pressure-sensitive adhesive, an acrylate adhesive, or a thermoplastic adhesive, respectively. In this manner, the separating plate 3 is enclosed between the bag-like interconnected separator foils 6, i.e. the separating plate 3 is provided in a separator foil bag, it being freely movably arranged in this separator foil bag.

On the other hand, the copper foils 5 are also glued to the separator foils 6 by means of adhesives, e.g. thermoplastic adhesives, in particular hot melt-type adhesives, or acrylate adhesives, in the manner of an adhesive seam 10.

When producing such a separating plate compound component 1 according to FIGS. 2 and 3, the separating plate 3 is laid on top of the lower, larger separator foil 6, and the adhesive seam 9 is applied to this lower separator foil 6. Subsequently, the upper separator foil 6 is applied over the separating plate 3 and the lower separator foil 6, and it is pressed at the adhesive seam 9 on the lower separator foil 6. In this manner, the separating plate 3 in the separator foil bag formed is protected and can no longer be contaminated. Subsequently, the copper foils 5 coated with resin 4 are glued together with their copper side, the so-called shiny side, to the respective upper or lower separator foil 6, the adhesive seam 10 at the outer rim being continuously provided. The resin side, i.e. the resin layers 4, face the adjacent arrangements 2, cf. FIG. 1, and the resin-coated copper foils 5 thus can form a part of the printed circuit boards to be produced.

In the variant according to FIGS. 4 and 5, a separating plate 3 is used which is larger than the copper foils 5 and which projects beyond the rims of the latter on all sides thereof. In the exemplary embodiment according to FIGS. 4 and 5, the separating plate 3 is directly coated with an anti-adhesive coating 16 which again serves to catch the resin of the prepreg layers 8 flowing out during the pressing procedure. Such collection of resin is possible because the separating plate 3 in this instance is larger than the remaining laminate assembly. The copper foils 5 again are glued via adhesive seams 10 on the the anti-adhesive coatings 16 to the separating plate 3 at the rim side thereof. As the material for the anti-adhesive coatings, a water-based (poly)olefin, such as the commercially available product TUF-LUBE 3C, a polyolefin emulsion from Tadco Inc., Woodinville, Wash., USA, may advantageously be used. Such an olefin is preferred because it is silicone-free and extremely environmentally friendly. The separating plates 3 may be of any suitable material, such as, e.g., of steel, in particular of special steel, but also of aluminium. Preferred is a metal, such as steel, having a minimum strength of 400 mPa, so as to avoid a so-called image transfer.

The separator foils 6 may consist of any suitable synthetic material, such as, e.g., PET or fluoropolymers.

As the adhesives for the adhesive seams 9, and 10, respectively, conventional pressure-sensitive adhesives, or thermoplastic adhesives, respectively, such as, in particular, the adhesive commercially available from ATO FINNEY under the name TSP353M may be used. Preferred are acrylate adhesives, such as, e.g., the alkoxy-alkyl-based adhesive DELO-CA® commercially available from DELO Industrie Klebstoffe, Landsberg, Germany, which decompose during the pressing procedure, i.e. lose their adhesive action.

By the described application of separator foils 6 or separator layers, respectively, or of anti-adhesive coatings serving as anti-adhesive layers 6 catching the synthetic resin during the pressing procedure, a contamination of the separating plates, or separating sheets 3, respectively, is safely avoided. This allows for a multiple use of this separating plates 3 without any problems, particularly doing away with the previously required laborious cleaning procedures for scratching off the synthetic resin. On the other hand, the use of synthetic-resin-coated copper foils 5 is enabled which enhances the production of printed circuit boards.

In FIG. 4, as an alternative, it is schematically illustrated that the copper foils 5 can also be connected to the separating metal plate 3 by laser welding sites 10′ passing through the anti-adhesive coatings 6, instead of such a connection by an adhesive seam.

1. A separating plate compound component (1) for producing printed circuit board components by compressing individual layers (7, 8) stacked with at least one such compound component, which compound component (1) includes a separating plate (3) between copper foils (5), characterised in that anti-adhesive-layers (6) are arranged on the separating plate (3) between the latter and the copper foils (5), wherein the copper foils (5) are glued to the anti-adhesive layers (6).

2. A compound component according to claim 1, characterised in that the copper foils (5) are coated with resin (4) on their sides remote from the anti-adhesive layers (6).

3. A compound component according to claim 1, characterised in that the copper foils (5) are glued to the anti-adhesive layers (6) by means of a thermoplastic adhesive, e.g. a hot melt-type adhesive.

4. A compound component according to claim 1, characterised in that the copper foils (5) are glued to the anti-adhesive layers (6) by means of an acrylate adhesive.

5. A compound component according to claim 1, characterised in that the separating plate (3) is a steel sheet.

6. A compound component according to claim 1, characterised in that the anti-adhesive layers (6) are formed by separate separator foils, projecting with a rim region beyond the separating plate (3) and being interconnected in these projecting rim regions, whereby the separating plate (3) is enclosed in a separator foil bag.

7. A compound component according to claim 6, characterised in that the separating plate (3) is freely movable within the separator foil bag.

8. A compound component according to claim 6, characterised in that the two separator foils (6) are interconnected via an adhesive seam (9).

9. A compound component according to claim 1, characterised in that the anti-adhesive layers (6) are formed by anti-adhesive coatings (16) applied on both sides of the separating plate (3), and that the separating plate (3) including the anti-adhesive coatings project beyond the copper foils (5) on all sides thereof.

10. A compound component according to claim 9, characterised in that the anti-adhesive coatings (6) are made of Teflon.

11. A compound component according to claim 9, characterised in that the anti-adhesive coatings (6) are made of a polyolefin.

12. A compound component according to claim 9, characterised in that the anti-adhesive coatings (6) are made of varnish.

13. A method of producing a separating plate compound component (1) to be used in the production of printed circuit board components by compressing individual layers (7, 8) stacked with at least one such compound component, which compound component (1) includes a separating plate (3) between copper foils (5), characterised in that a separating plate (3) is laid on a comparatively larger anti-adhesive separator foil (6) and an adhesive seam (9) is peripherally applied to the separator foil (6), whereupon an upper anti-adhesive separator foil (6) which also is larger as compared to the separating plate (3) is laid thereon and is pressed with its rim region that projects over the separating plate (3) at the adhesive seam (9), whereafter copper foils (5) are glued to the separator foils (6).

14. A method according to claim 13, characterised in that the adhesive seam (9) is produced by means of a thermoplastic adhesive.

15. A method according to claim 13, characterised in that the adhesive seam (9) is made by means of an acrylate adhesive.
